(19) United States
(12) Patent Application Publication
(10) Pub. No.: US 2018/0077115 A1
(43) Pub. Date: Mar. 15, 2018

(54) ALIAS STRINGS

(71) Applicant: Hewlett-Packard Development Company, L.P., Houston, TX (US)

(72) Inventors: Jun-Min Miao, Shanghai (CN); Wei Wu, Shanghai (CN)

(73) Assignee: Hewlett-Packard Development Company, L.P., Houston, TX (US)

(21) Appl. No.: 15/558,929

(22) PCT Filed: May 29, 2015
(86) PCT No.: PCT/CN2015/080306

§ 371 Date: Sep. 15, 2017

(51) Int. Cl. H04L 29/12

(52) U.S. Cl. CPC H04L 61/3015; H04L 61/6022; H04L 61/3065

(57) ABSTRACT

Examples disclosed herein relate, among other things, to a computing device. The computing device may include an alias engine to obtain an identifier of an electronic device, to determine, based on the identifier, at least one dictionary term, and generate, based on the dictionary term, an alias string. The computing device may also include an output engine to store the alias string in association with the electronic device.

### BACKGROUND

A computing device may be connected to numerous electronic devices, such as printers, scanners, displays, wireless routers, and so forth. Each electronic device may be identified with one or more identifiers such as a serial number, a media access control (MAC) address, an internet protocol (IP) address, a manufacturer name, a model name or number, and so forth. In order to configure, use, or otherwise communicate with a particular electronic device, the user of the computing device may first identify the particular electronic device among all the available electronic devices.

### BRIEF DESCRIPTION OF THE DRAWINGS

The following detailed description references the drawings, wherein:

FIG. 1A is a block diagram of an example computing system;

FIG. 1B is another block diagram of an example computing system;

FIG. 2 illustrates an example identifier and an example alias string;

FIG. 3 illustrates an example computing device;

FIG. 4 is a flowchart illustrating an example method generating an alias string; and

FIG. 5 illustrates an example computing device.

### DETAILED DESCRIPTION

As discussed above, an electronic device may be identified using one or more identifiers. Some identifiers, however, may not uniquely identify the device among all devices connected to the computing device. For example, if the electronic device is identified by a manufacturer name and a model number, the computing device may be connected to two or more devices from the same manufacturer and of the same model. Other identifiers, such as a MAC address or a serial number, may uniquely identify the electronic device among all electronic devices, but those identifiers may be represented by characters that are not very meaningful and that may be difficult to remember. Accordingly, a user looking at a list of identifiers of multiple devices connected to the computing device may find it difficult to distinguish between similarly named devices or to remember which electronic device corresponds to which identifier. Sometimes a user may manually assign a custom name to the electronic device. However, as the number of interconnected electronic devices grows, manually assigning custom names to multiple devices while making sure that the assigned names do not conflict with already existing names may be a difficult task.

Examples disclosed herein relate, among other things, to a computing device coupled to an electronic device. The computing device may include, for example, an alias engine and an output engine. The alias engine may obtain an identifier of an electronic device, determine, based on the identifier, a plurality of dictionary terms, and generate an alias string based on the plurality of dictionary terms. The output engine may then store the alias string in association with the electronic device.

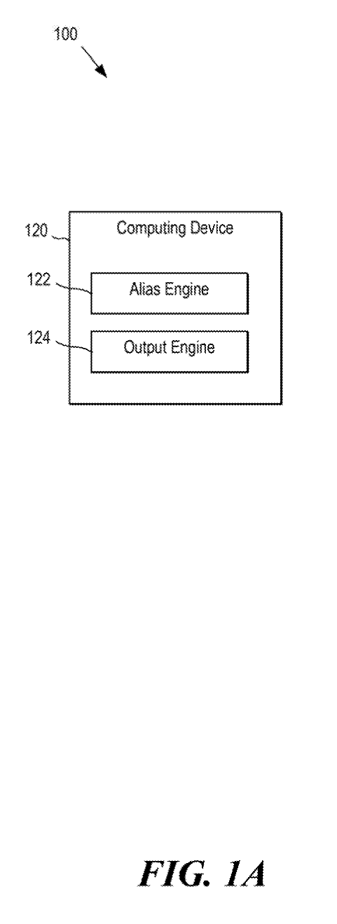

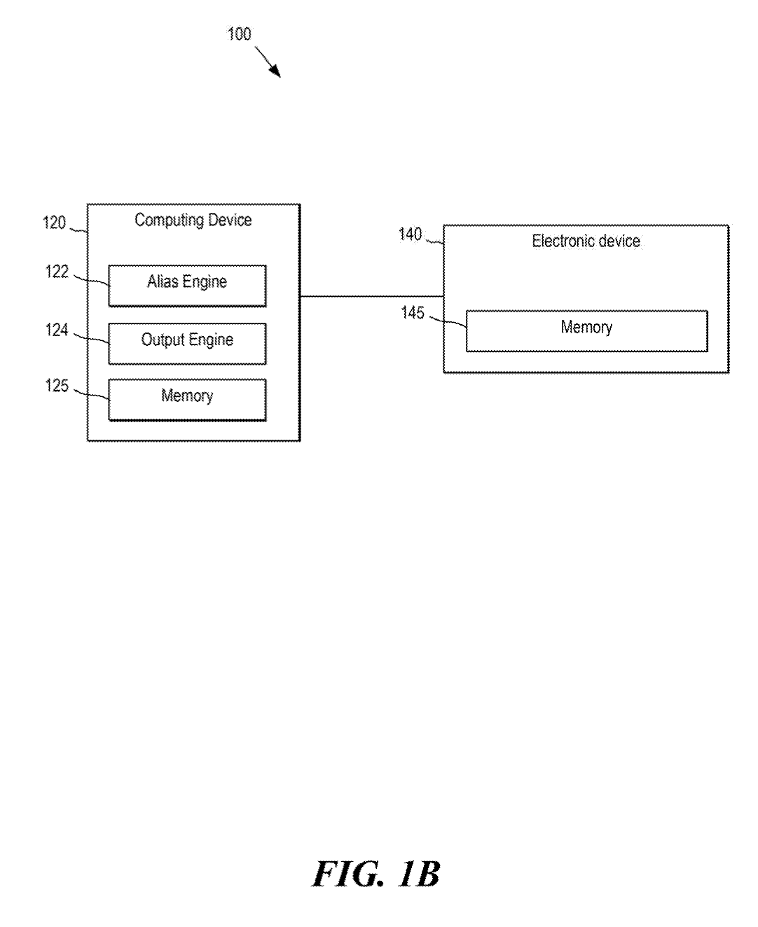

FIG. 1A is a block diagram of an example computing system 100 that includes an example computing device 120. As illustrated in FIG. 1B, computing system 100 may also include an electronic device 140 coupled to computing device 120. Computing system 100 may include, among other things, a computing device 120 and an electronic device 140. Computing device 120 may be any type of an electronic device such as a mobile phone (e.g., smartphone), a tablet, a laptop, a desktop, a workstation, a server, a printing device (e.g., a personal printer, a networked or shared printer, a commercial or industrial printer, a 3D printer, a multifunction printer (MFP), etc.), a scanner, a copier, a fax, an all-in-one device, a projector, a smart television, a wearable computing device (e.g., smart watch or other smart computing apparel), a retail point of sale device, a display, a camera, a gaming device, an application-specific computing device or any other type of processing device or equipment including a processor. In some examples, computing device 120 may include two or more communicatively coupled computing devices.

Similarly, electronic device 140 may be any type of an electronic device such as a mobile phone (e.g., smartphone), a tablet, a laptop, a desktop, a workstation, a server, a printing device (e.g., a personal printer, a networked or shared printer, a commercial or industrial printer, a 3D printer, a multifunction printer (MFP), etc.), a scanner, a copier, a fax, an all-in-one device, a projector, a smart television, a wearable computing device (e.g., smart watch or other smart computing apparel), a retail point of sale device, a display, a camera, a gaming device, an application-specific computing device or any other type of processing device or equipment including a processor.

In some examples, computing device 120 and electronic device 140 may be parts of or integrated into the same device. In other examples, computing device 120 and electronic device 140 may be separate devices communicatively coupled to each in a wired or wireless fashion. For example, devices 120 and 140 may be connected via at least one wired and/or wireless network, such as a wide-area network (e.g., the Internet), a local-area network, and so forth.

In some examples, computing device 120 may include a memory 125, and electronic device 140 may include a memory 145. Memories 125 and 145 may each include any type of non-transitory memory that may include any combination of volatile and non-volatile memory. For example, each memory may include any combination of random-access memories (RAMs), read-only memories (ROMs), flash memories, hard drives, memristor-based memories, and the like. In some examples, e.g., if computing device 120 and electronic device 140 are integrated into the same device, memories 125 and 145 may refer to the same memory.

In some examples, computing device 120 may include an alias engine 122. Alias engine 122 may be implemented in the form of instructions (e.g., stored on a machine-readable storage medium) that, when executed (e.g., by a processor of computing device 120 not shown in FIGS. 1A and 1B for brevity), may implement the functionality of alias engine 122. In some examples, the instructions may be part of an operating system (OS), or part of at least one software driver and/or application, such as a driver or application associated with electronic device 140 and installed on computing device 120 to communicate with and control electronic device 140. Alternatively or in addition, alias engine 122 may include electronic circuitry (i.e., hardware) that implements the functionality described below.

In some examples, engine 122 may obtain at least one identifier of electronic device 140. For example, engine 122 may communicate with electronic device 140 (e.g., via at least one network), request from electronic device 140 at least one of its identifiers, and receive the identifier(s) in response to the request. In some examples, the identifier(s) may be stored in memory 145 and may be fetched by electronic device 140 from memory 145 and sent to computing device 120. As discussed above, an identifier may be a MAC address, an IP address, a serial number, a manufacturer name, a model name or number, or any other type of identifier associated with electronic device 140.

After obtaining at least one identifier of electronic device 140, alias engine 122 may determine, based on the identifier, a plurality of (e.g., two or more) dictionary terms. The plurality of dictionary terms may be obtained by engine 122, for example, from a database stored, for example, in memory 125, memory 145, or any other memory on device 120, device 140, or any other local or remote device communicatively coupled to device 120 or device 140.

The database may store at least one dictionary term, where a “dictionary term” as used herein may refer to any word or combination of words in a particular language. In some examples, the database may include dictionary terms in the language of the geographical region (e.g., country or province) associated with electronic device 140, where the geographical region may be manually set by the manufacturer, manually selected by the user, or automatically determined by electronic device 140. The dictionary terms stored in the database may include, for example, words appearing in standard dictionaries (e.g., the Oxford English Dictionary), geographical locations, names of people, or any other types of recognizable words. In some examples, the database may include a plurality of databases, where each of the plurality of databases may store a different set of dictionary terms, where the different sets may or may not overlap. For example, a particular database may store only words of a certain type of speech (e.g., only nouns or only adjectives), only words of a certain category (e.g., types of animals or colors), etc.

As mentioned above, engine 122 may determine a plurality of dictionary terms based on the obtained identifier. For example, engine 122 may map the identifier into the plurality of dictionary terms using an injective (i.e., one-to-one) mapping function, such that no two identifiers may be mapped into the same plurality of dictionary terms. Accordingly, in some examples, engine 122 may map unique identifiers (e.g., MAC addresses or serial numbers) into unique pluralities of dictionary terms, such that no two identifiers are mapped into the same plurality of dictionary terms, and such that for each electronic device, a unique plurality of dictionary terms may be determined.

In some examples, engine 122 may use a mapping function to map the obtained identifier into a plurality of indexes, and then use the obtained indexes to determine a plurality of dictionary terms. As discussed above, in some examples, the mapping function may be an injective (one-to-one) function, in which case no two identifiers may be mapped into the same combination of indexes. In some examples, the obtained indexes may be used directly as keys to the same database storing dictionary terms. In other examples, each index may be used as a key to a different database storing a different set of dictionary terms.

In some examples, engine 122 may divide the identifier into a plurality of portions (e.g., into different sets of bits) and independently map each portion of the identifier into a dictionary term. In other examples, the same portion of the identifier may be used by engine 122 to determine two or more dictionary terms. Also, while in some examples engine 122 may use the entire value (i.e., all bits) of the identifier to determine the plurality of dictionary terms, in other examples engine 122 may use only a portion (e.g., some bits) of the obtained identifier to determine the plurality of dictionary terms.

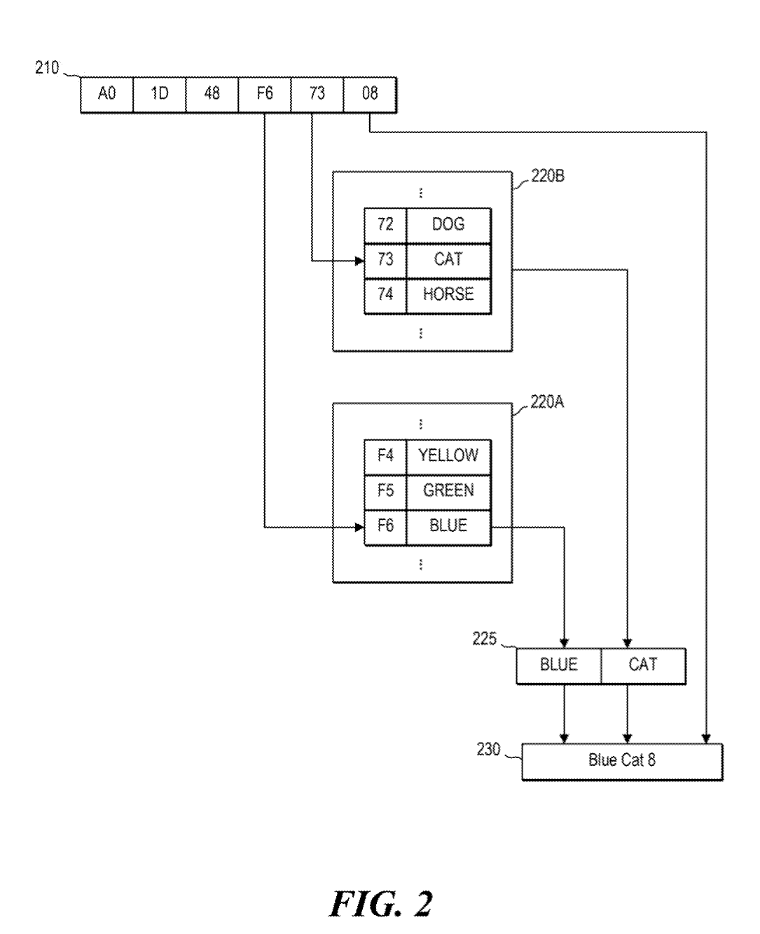

To illustrate, FIG. 2 shows are example in which engine 122 obtains an identifier 210 of electronic device 140 and based on identifier 210 determines a plurality of dictionary terms 225, based on which an alias string 230 is then constructed. Specifically, in the example of FIG. 2, identifier 210 is a 48-bit version of a MAC address. In this example, engine 112 uses bits 23:16 of identifier 210 as an index to database 220A storing color names, and bits 15:8 of identifier 210 are used as an index to database 220B storing types of animals. Based on the two indexes, engine 112 determines the plurality of dictionary terms 225, specifically, “BLUE” and “CAT.” While in this example portions of identifier 210 are used directly as database indexes, as discussed above, in other examples engine 122 may employ any suitable function to map the identifier into a plurality of dictionary terms, either by first dividing the identifier into a plurality of portions and mapping the plurality of portions into a plurality of database indexes, or by using any other suitable method.

After determining a plurality of dictionary terms, engine 112 may use the dictionary terms to generate an alias string. The alias string may include a plurality of characters such as letters, digits, punctuation marks, special symbols, or any other type of characters. In some examples, the generated alias string may include the determined plurality of dictionary terms as they appear in the database (or a plurality of databases) without modifying the terms. In other examples, engine 112 may modify at least one of the determined dictionary terms. For example, engine 112 may modify at least one dictionary term to make the terms correspond to each other in terms of grammar. As another example, engine 112 may change the case of the terms, for example, to capitalize the first letter of each term, as illustrated in FIG. 2.

In some examples, the alias string may include, in addition to the (optionally modified) dictionary terms, additional strings, letters, symbols, digits, or other characters. To illustrate, in the example of FIG. 2, engine 112 generates alias string 225 that includes two case-modified dictionary terms 225, two space characters, and a number “8” corresponding to the least significant byte of identifier 210. Thus, it is appreciated that in other examples, engine 112 may include in the generated string any number of predefined characters or characters corresponding to or equivalents of identifier 210 or portions thereof.

In some examples, a portion of the identifier of the electronic device may be used to uniquely identify the vendor, manufacturer, or another organization associated with electronic device 140. For example, an identifier may be a 48-bit MAC address whose three most significant bytes represent an organizationally unique identifier (OUI) and three least significant bytes represent a unique network interface controller (NIC) of the electronic device. In these examples, engine 112 may, for example, generate the alias string based on the NIC bytes only, in which case the alias string may uniquely identify electronic device 140 among all devices from the same manufacturer. Alternatively, engine 112 may generate the alias string based on the entire 48-bit MAC address, in which case the alias string may uniquely identify electronic device 140 among all devices from all manufacturers. Thus, using techniques described herein, an electronic device can be automatically assigned an alias string that is meaningful, recognizable, and easy to remember, and that is unique among a plurality of electronic devices (e.g., among all devices from the same manufacturer, all devices of the same type (e.g. all printers), all devices connected to a particular computing device 120, etc.)

In some examples, to facilitate identification of various electronic devices, engine 122 may also obtain an alias image associated with the obtained identifier of electronic device 140. In some examples, the alias image may be associated with the generated string. For example, the alias image may include (i.e., visually represent) all the dictionary terms included in the alias string, or at least some of the dictionary terms. In some examples, the databases (e.g., 220A and 220B) may also store, for each dictionary term, an image representing the term, and engine 112 may combine the plurality of images into a single alias image. In other examples, engine 112 may access a database storing images representing all possible combinations of dictionary terms, and obtain from the database an image, representing the combination of dictionary terms included in the alias string, as discussed above.

In the above examples, the plurality of dictionary terms are described as being determined based on an identifier of electronic device 140. It is appreciated, however, that in other examples the plurality of dictionary terms may be determined, using the above-described techniques, based on a combination of two or more identifiers of electronic device 140, where the combination may or may not be unique combination. In some examples, the plurality of dictionary terms may also be determined based on factors unrelated to electronic device 140.

In some examples, computing device 120 may also include an output engine 124. Output engine 124 may be implemented in the form of instructions (e.g., stored on a machine-readable storage medium) that, when executed (e.g., by a processor of computing device 120 not shown in FIGS. 1A and 1B for brevity), may implement the functionality of output engine 124. In some examples, the instructions may be part of an operating system (OS), or part of at least one software driver and/or application, such as a driver or application associated with electronic device 140 and installed on computing device 120 to communicate with and control electronic device 140. Alternatively or in addition, output engine 124 may include electronic circuitry (i.e., hardware) that implements the functionality described below.

In some examples, output engine 124 may obtain the generated alias string and/or alias image from alias engine 122 and provide the generated alias string and/or alias image for storage in association with electronic device 140. For example, output engine 124 may cause the alias string and/or alias image to be stored together with at least one identifier (e.g., a MAC address, an IP address, a serial number, etc.) of electronic device 140. Output engine 124 may cause the alias string and/or alias image to be stored in a volatile and/or non-volatile memory on computing device 120, on electronic device 140, or on at least one other device. For example, output engine 124 may store the alias string and/or alias image in memory 125, or send the alias string and/or alias image to electronic device 140 causing electronic device to store the alias string and/or alias image in memory 145. In some examples, the alias string and/or image may be stored in an alias database that stores alias strings and/or images for a plurality of electronic devices.

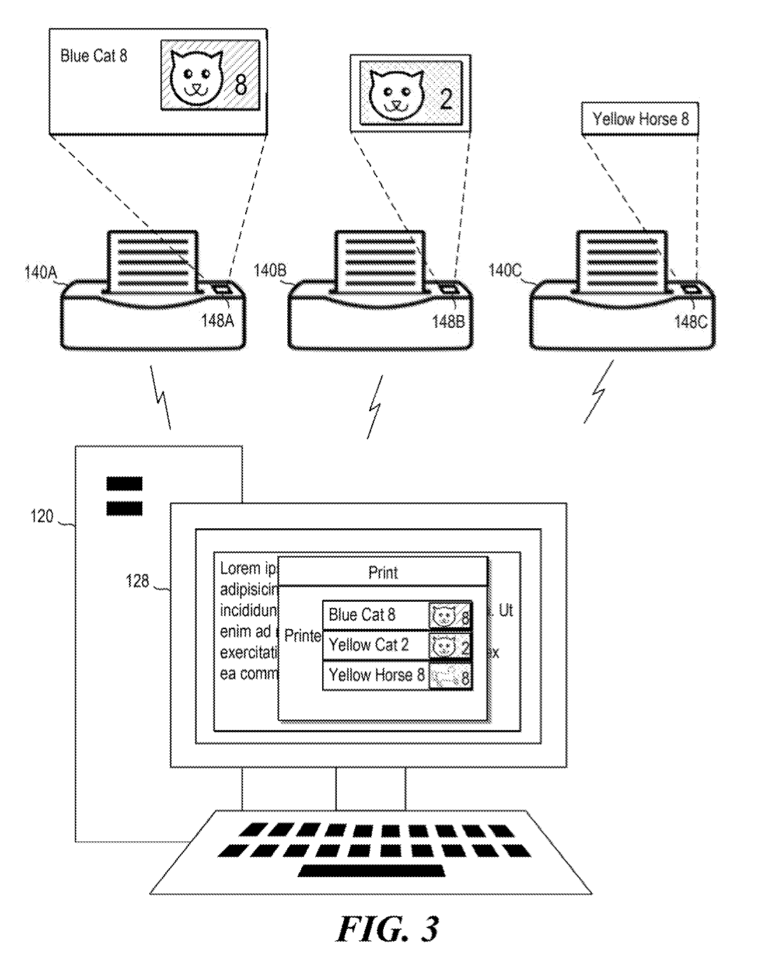

The stored alias string and/or alias image may be fetched from the memory (e.g., 125 or 145) by computing device 120 or any other computing device connected to electronic device 140 and presented to the user of that computing device. To illustrate, FIG. 3 shows an example in which a user of computing device 120 wishes to choose an electronic device (in this example, a printer) from a plurality of printers connected to computing device 120. In this example, computing device 120 displays on a display 128 coupled to computing device 120 a list of printers connected to computing device 120. For each printer in the list, computing device 120 displays the printer's alias string and alias image. In some examples (not shown for brevity) in addition to the alias string and/or alias image, computing device 120 may display, for each printer, at least one of the printer's identifiers such as the printer's MAC address, IP address, serial number, manually assigned custom name, or any other information associate with the printer.

In some examples, instead or in addition to displaying the alias string and/or image on a display coupled to computing device 120, the alias string and/or image generated by computing device 120 for electronic device 140 may be displayed (e.g., by electronic device 140) on a display coupled to electronic device 140. In some examples, electronic device 140 may determine whether the parameters of its display (e.g., resolution, aspect ratio, color representation, etc.) enable it to display the alias image, the alias string, or both.

For example, in FIG. 3, electronic devices 140A, 140B, and 140C are equipped with embedded displays 148A, 148B, and 148C, respectively. In this example, electronic device 140A obtains (e.g., from memory 145) the alias string and image generated for it by computing device 120, and determines, based on the parameters of display 148A, that display 148A is capable of displaying both the alias string and the alias image. Accordingly, electronic device 140A displays both the string and the image, along with any other relevant information (not shown for brevity), on display 148A. The displayed alias string and image may allow the user to identify electronic device 140A among other electronic devices 140. Similarly, electronic device 140B determines that its display 148B is capable of displaying the alias image but not the alias string, and therefore electronic device 140B displays only the alias image on display 148B. In turn, electronic device 140C determines that display 148C is capable of displaying the alias string but not the alias image, and therefore electronic device 140C displays only the alias string on display 148B.

In foregoing discussion, alias engine 122 and output engine 124 were described as any combinations of hardware and programming. Such components may be implemented in a number of fashions. The programming may be processor executable instructions stored on a tangible, non-transitory computer readable medium and the hardware may include a processing resource for executing those instructions. The processing resource, for example, may include one or multiple processors (e.g., central processing units (CPUs), semiconductor-based microprocessors, graphics processing units (GPUs), field-programmable gate arrays (FPGAs) configured to retrieve and execute instructions, or other electronic circuitry), which may be integrated in a single device or distributed across devices. The computer readable medium can be said to store program instructions that when executed by the processor resource implement the functionality of the respective component. The computer readable medium may be integrated in the same device as the processor resource or it may be separate but accessible to that device and the processor resource. In one example, the program instructions can be part of an installation package that when installed can be executed by the processor resource to implement the corresponding component. In this case, the computer readable medium may be a portable medium such as a CD, DVD, or flash drive or a memory maintained by a server from which the installation package can be downloaded and installed. In another example, the program instructions may be part of an application or applications already installed, and the computer readable medium may include integrated memory such as a hard drive, solid state drive, or the like.

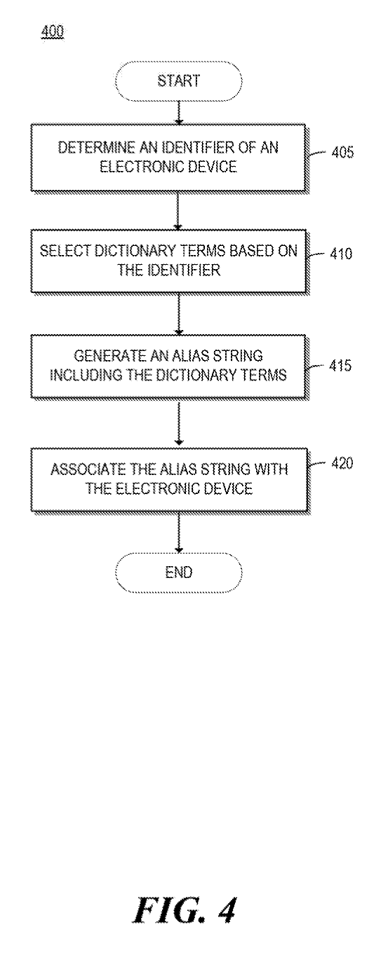

FIG. 4 is a flowchart of an example method 400 for generating an alias string. Method 400 may be described below as being executed or performed by a system (e.g., computing system 100) or by at least one device. For example, method 400 may be performed by computing device 120 or by electronic device 140 of FIG. 1B. For example, method 400 may be performed at a factory line during the assembly and initial configuration of electronic device 140, in which case the generated alias string and/or alias image may be stored in (e.g., permanently burnt into) memory 145. As another example, method 400 may be performed during an installation or an update of a software driver of electronic device 140 on computing device 120, in which case the generated alias string and/or alias image may be stored into memory 125. Method 400 may also be performed during other times and/or by other suitable systems and/or computing devices.

Method 400 may be implemented in the form of executable instructions stored on at least one non-transitory machine-readable storage medium of the system and executed by at least one processor of the system. Alternatively or in addition, method 400 may be implemented in the form of electronic circuitry (e.g., hardware). In alternate examples of the present disclosure, at least one block of method 400 may be executed substantially concurrently or in a different order than shown in FIG. 4. In alternate examples of the present disclosure, method 400 may include more or less blocks than are shown in FIG. 4. In some examples, at least one block of method 400 may, at certain times, be ongoing and/or may repeat.

At block 405, method 400 may determine an identifier of an electronic device (e.g., 140). At block 410, the method may select, based on the identifier, a plurality of dictionary terms from a database. As discussed above, selecting a plurality of dictionary terms may include determining a plurality of dictionary indexes based on the identifier, and in some examples, each of the plurality of indexes may be determined based on a different portion of the identifier.

At block 415, the method may generate an alias string that includes at least each of the plurality of dictionary terms selected at block 410. At block 420, the method may associate the alias string with the electronic device. As discussed above, associating the alias string with the electronic device may include storing the alias string in a database in association with a media access control (MAC) address of the electronic device and/or with an internet protocol (IP) address of the electronic device, where the database may include a plurality of other alias strings associated with a plurality of other electronic devices. In some examples (not shown in FIG. 4 for brevity) method 400 may also include a block at which the method provides the alias string for display on a display.

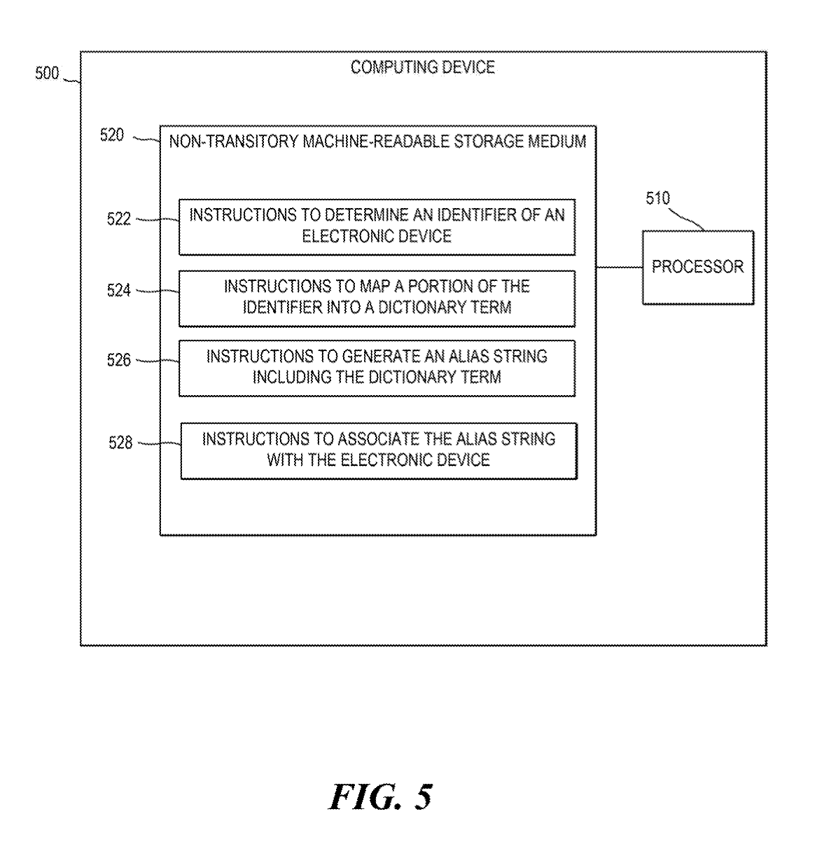

FIG. 5 is a block diagram of an example computing device 500. In some examples, computing device 500 may be similar to computing device 120 of FIGS. 1A and 1B. In the example of FIG. 5, computing device 500 includes a processor 510 and a non-transitory machine-readable storage medium 520. Although the following descriptions refer to a single processor and a single machine-readable storage medium, it is appreciated that multiple processors and multiple machine-readable storage mediums may be anticipated in other examples. In such other examples, the instructions may be distributed (e.g., stored) across multiple machine-readable storage mediums and the instructions may be distributed (e.g., executed by) across multiple processors.

Processor 510 may include at least one central processing unit (CPU), microprocessor, and/or another hardware device suitable for retrieval and execution of instructions stored in non-transitory machine-readable storage medium 520. In the particular example shown in FIG. 5, processor 510 may fetch, decode, and execute instructions 522, 524, 526, 528, or any other instructions (not shown for brevity). As an alternative or in addition to retrieving and executing instructions, processor 510 may include at least one electronic circuit comprising a number of electronic components for performing the functionality of at least one of the instructions in machine-readable storage medium 520. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Non-transitory machine-readable storage medium 520 may be any electronic, magnetic, optical, or other physical storage device that stores executable instructions. Thus, medium 520 may be, for example, Random Access Memory (RAM), an Electrically-Erasable Programmable Read-Only Memory (EEPROM), a storage drive, an optical disc, and the like. Medium 520 may be disposed within computing device 500, as shown in FIG. 5. In this situation, the executable instructions may be “installed” on computing device 500. Alternatively, medium 520 may be a portable, external or remote storage medium, for example, that allows computing device 500 to download the instructions from the portable/external/remote storage medium. In this situation, the executable instructions may be part of an “installation package”. As described herein, medium 520 may be encoded with executable instructions. The instructions may be executed, for example, during assembly and initial configuration of electronic device 140 at a factory line, during an installation or an update of a software driver of electronic device 140 on computing device 120, or during any other time.

Instructions 522, when executed by a processor (e.g., 510), may cause a computing device (e.g., 500) to determine an identifier of an electronic device (e.g., 140). Instructions 524, when executed by the processor, may cause the computing device to use a mapping function (e.g., a one-to-one function) to map a portion of the identifier to a dictionary term. Instructions 526, when executed by the processor, may cause the computing device to generate an alias string that includes the dictionary term. Instructions 528, when executed by the processor, may cause the computing device to associate the alias string with the electronic device. As discussed above, associating the alias string with the electronic device may include sending the alias string to the electronic device for storage on the electronic device, or storing the alias string in a database that stores plurality of unique alias strings associated with a plurality of electronic devices.

What is claimed is:

1. A computing device comprising:
an alias engine to:
obtain an identifier of an electronic device,
based on the identifier, determine a plurality of dictionary terms, and
generate an alias string based on the plurality of dictionary terms; and
an output engine to store the alias string in association with the electronic device.

2. The computing device of claim 1 wherein the identifier comprises one of: a media access control (MAC) address of the electronic device and a serial number of the electronic device.

3. The computing device of claim 1, wherein determining the plurality of dictionary terms comprises mapping a first portion of the identifier to a first dictionary term, and mapping a second portion of the identifier to a second dictionary term.

4. The computing device of claim 1, wherein the plurality of dictionary terms comprises a first set of dictionary terms and a second set of dictionary terms, and wherein determining the plurality of dictionary terms comprises determining a first dictionary term from the first set based on a first portion of the identifier and determining a second dictionary term from the second set based on a second portion of the identifier.

5. The computing device of claim 1, wherein the device alias comprises a string comprising the plurality of dictionary terms.

6. The computing device of claim 1, wherein the alias generator is further to obtain an alias image associated with the generated alias string, and wherein the output engine is further to store the alias image in association with the electronic device.

7. The computing device of claim 6, wherein obtaining the alias image comprises:
obtaining a first image associated with a first term from the plurality of dictionary terms;
obtaining a second image associated with a second term from the plurality of dictionary terms; and
generating the alias image based on the first image and the second image.

8. A method comprising:
determining an identifier of an electronic device;
based on the identifier, selecting a plurality of dictionary terms from a database;
generating an alias string comprising each of the plurality of dictionary terms; and
associating the alias string with the electronic device.

9. The method of claim 8, wherein associating the alias string with the electronic device comprises:
providing the alias string for storage in a non-volatile memory of the electronic device; or
providing the alias string for storage in a database in association with a media access control (MAC) address of the electronic device or an internet protocol (IP) address of the electronic device.

10. The method of claim 8, wherein selecting a plurality of dictionary terms comprises determining a plurality of dictionary indexes based on the identifier.

11. The method of claim 10, wherein each of the plurality of dictionary indexes is determined based on a different portion of the identifier.

12. The method of claim 8, further comprising providing the alias string for display on a display.

13. A non-transitory machine-readable storage medium encoded with instructions executable by a processor of a computing device to cause the computing device to:
determine an identifier of an electronic device;
use a mapping function to map a portion of the identifier to a dictionary term;
generate an alias string comprising the dictionary term; and
associate the alias string with the electronic device.

14. The non-transitory machine-readable storage medium of claim 13 wherein associating the alias string with the electronic device comprises sending the alias string to the electronic device for storage on the electronic device.

15. The non-transitory machine-readable storage medium of claim 13, wherein associating the alias string with the electronic device comprises storing the alias string in a database, where the database stores a plurality of unique alias strings associated with a plurality of electronic devices.
